(19) United States
(12) Patent Application Publication
(10) Pub. No.: US 2011/0281198 A1
(43) Pub. Date: Nov. 17, 2011

(54) FUEL CELL

(76) Inventors: Naoki IWAMURA, Kawasaki-shi (JP); Nobuyasu Negishi, Ibaraki-shi (JP); Hiroshi Yamazaki, Ibaraki-shi (JP)

(21) Appl. No.: 13/188,192

(22) Filed: Jul. 21, 2011

Related U.S. Application Data
(63) Continuation of application No. PCT/JP2010/051440, filed on Feb. 2, 2010.

(30) Foreign Application Priority Data
Feb. 20, 2009 (JP) 2009-038214

(51) Int. Cl. H01M 4/64; H01M 8/10

(52) U.S. Cl. 429/482

(57) ABSTRACT

According to one embodiment, a fuel cell includes a membrane electrode assembly including an anode, a cathode, and an electrolyte membrane interposed between the anode and the cathode, and an electricity-collecting member including an anode electricity collector having a first electrode member which is in contact with the anode, a cathode electricity collector having a second electrode member which is in contact with the cathode, a connection portion having a conductor which connects the anode electricity collector and the cathode electricity collector, and an insulative protection film covering at least the conductor of the connection portion.

### CROSS REFERENCE TO RELATED APPLICATIONS

This application is a Continuation Application of PCT Application No. PCT/JP2010/051440, filed Feb. 2, 2010 and based upon and claiming the benefit of priority from prior Japanese Patent Application No. 2009-038214, filed Feb. 20, 2009, the entire contents of all of which are incorporated herein by reference.

### FIELD

Embodiments described herein relate generally to a fuel cell.

### BACKGROUND

In recent years, an attempt has been made to use a fuel cell as a power supply of various kinds of portable electronic apparatuses such as a notebook personal computer and a mobile phone, thereby to make such electronic apparatuses usable for a long time without charging. The fuel cell has such a feature that electricity can be generated by only supplying fuel and air (especially, oxygen) and electricity can continuously be generated for a long time by replenishing fuel. Thus, by reducing the size of the fuel cell, the fuel cell can become a very advantageous system as a power supply of the portable electronic apparatus.

In particular, a direct methanol fuel cell (hereinafter referred to as “DMFC”), which uses methanol as fuel, is regarded as a promising power supply of the portable electronic apparatus, since the size can be reduced and the handling of fuel is easy.

In the fuel cell, the voltage, which is obtained from a unit cell, is a relatively low voltage. Thus, in many cases, when the fuel cell is used, a plurality of unit cells are connected in series, thereby boosting the voltage. For example, as an electricity-collecting member for electrically connecting unit cells, there is disclosed a structure wherein an electricity-collecting member includes a plurality of conductor layers on one side of a substrate, the electricity-collecting member being folded to clamp an air electrode and a fuel electrode. In addition, for example, there is disclosed a structure wherein an electricity-collecting member is folded double in the state in which a cathode conductive layer and an anode conductive layer are integrally provided on a single insulative film, thereby accommodating a membrane electrode assembly between the two folded pieces.

When such an electricity-collecting member is folded, there is a concern that breaking may occur in the conductive layer which extends through the folded part.

The DMFC is required to have corrosion resistance to methanol or formic acid.

### BRIEF DESCRIPTION OF THE DRAWINGS

FIG. 1 is a cross-sectional view which schematically shows the structure of a fuel cell according to an embodiment.

FIG. 2 is a plan view of a membrane electrode assembly shown in FIG. 1.

FIG. 3 is a perspective view which schematically shows a partial cross-sectional structure, taken along line of the membrane electrode assembly shown in FIG. 2.

FIG. 4 is a plan view which schematically shows a structure of an electricity-collecting member, which is applicable to the embodiment.

FIG. 5 is a cross-sectional view showing a structure example of the electricity-collecting member shown in FIG. 4.

FIG. 6 is a cross-sectional view showing another structure example of the electricity-collecting member shown in FIG. 4.

FIG. 7 is a cross-sectional view showing still another structure example of the electricity-collecting member shown in FIG. 4.

FIG. 8 is a cross-sectional view showing still another structure example of the electricity-collecting member shown in FIG. 4.

FIG. 9 is a view for explaining a method of a folding test.

FIG. 10 shows a test result of the folding test.

### DETAILED DESCRIPTION

In general, according to one embodiment, a fuel cell includes a membrane electrode assembly including an anode, a cathode, and an electrolyte membrane interposed between the anode and the cathode; and an electricity-collecting member including an anode electricity collector having a first electrode member which is in contact with the anode, a cathode electricity collector having a second electrode member which is in contact with the cathode, a connection portion having a conductor which connects the anode electricity collector and the cathode electricity collector, and an insulative protection film covering at least the conductor of the connection portion.

In general, according to another embodiment, a fuel cell includes a membrane electrode assembly including an anode, a cathode, and an electrolyte membrane interposed between the anode and the cathode; and an electricity-collecting member including an anode electricity collector having a first electrode member which is in contact with the anode, a cathode electricity collector having a second electrode member which is in contact with the cathode, an anode terminal including a first conductor connected to the anode electricity collector, a cathode terminal including a second conductor connected to the cathode electricity collector, and an insulative protection film covering at least one of the first conductor of the anode terminal and the second conductor of the cathode terminal.

A fuel cell according to an embodiment will now be described with reference to the drawings.

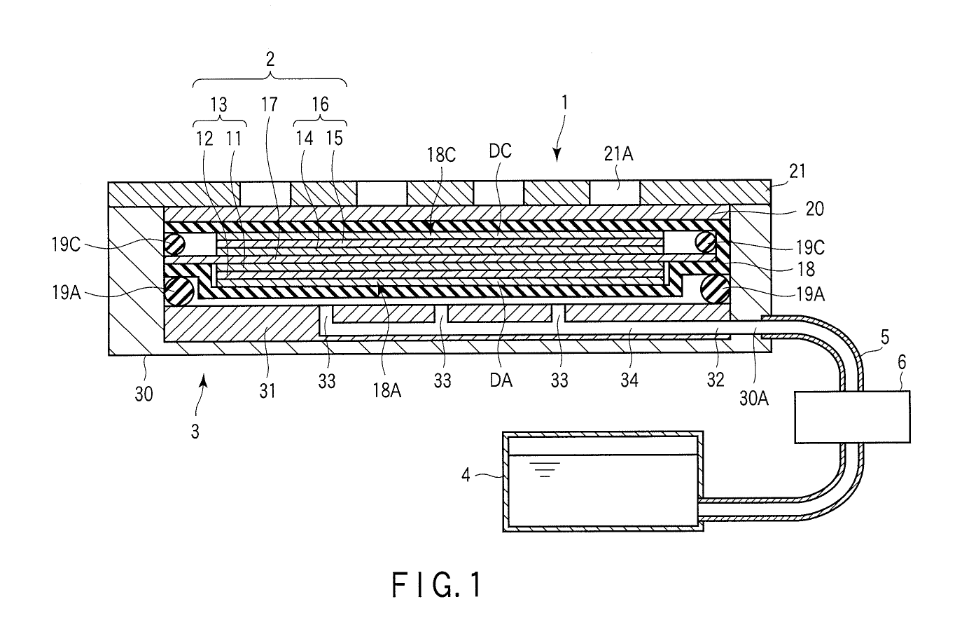

As shown in FIG. 1, a fuel cell 1 is configured to include a membrane electrode assembly (also referred to as “MEA”) 2 which constitutes a power generation section.

Specifically, the membrane electrode assembly 2 comprises an anode (also referred to as “fuel electrode”) 13 including an anode catalyst layer 11 and an anode gas diffusion layer 12; a cathode (also referred to as “air electrode” or “oxidant electrode”) 16 including a cathode catalyst layer 14 and a cathode gas diffusion layer 15; and a proton (hydrogen ion)-conducting electrolyte membrane 17 which is interposed between the anode catalyst layer 11 and cathode catalyst layer 14.

The membrane electrode assembly 2 is sealed by an anode seal member 19A which is disposed on the anode side of the electrolyte membrane 17, and a cathode seal member 19C which is disposed on the cathode side of the electrolyte membrane 17. Thereby, fuel leak or oxidant leak from the membrane electrode assembly 2 is prevented. The anode seal member 19A is formed in a frame shape surrounding the anode 13. The cathode seal member 19C is formed in a frame shape surrounding the cathode 16. The anode seal member 19A and cathode seal member 19C are formed of, e.g. rubber-made O rings.

A plate-like member 20, which is formed of an insulative material, is disposed on the cathode 16 side of the membrane electrode assembly 2. The plate-like member 20 functions mainly as a moisture retention layer. Specifically, the plate-like member 20 is impregnated with part of water which is generated in the cathode catalyst layer 14, and suppresses evaporation of water. In addition, the plate-like member 20 adjusts an intake amount of air into the cathode catalyst layer 14, and promotes uniform diffusion of air.

The above-described membrane electrode assembly 2 is clamped by the double-folded electricity-collecting member 18. The electricity-collecting member 18 comprises an anode electricity collector 18A, which includes an electrode member DA that is in contact with the anode 13, and a cathode electricity collector 18C, which includes an electrode member DC that is in contact with the cathode 16. The electrode member DA of the anode electricity collector 18A is stacked on the anode gas diffusion layer 12 in each unit cell C. In addition, the electrode member DC of the cathode electricity collector 18C is stacked on the cathode gas diffusion layer 15 in each unit cell C.

The above-described membrane electrode assembly 2 is disposed between a fuel supply mechanism 3, which supplies fuel to the membrane electrode assembly 2, and a cover plate 21.

The fuel supply mechanism 3 is configured to supply fuel to the anode 13 of the membrane electrode assembly 2. The structure of the fuel supply mechanism 3, however, is not limited to a specific one. An example of the fuel supply mechanism 3 is described below.

The fuel supply mechanism 3 includes a container 30 which is formed, for example, in a box shape. The fuel supply mechanism 3 is connected to a fuel container 4, which contains a liquid fuel, via a conduit 5. The container 30 includes a fuel introducing port 30A, and this fuel introducing port 30A and the conduit 5 are connected.

The fuel supply mechanism 3 includes a fuel supply unit 31 which supplies fuel in a plane direction of the anode 13 of the membrane electrode assembly 2, while dispersing and diffusing the fuel. Specifically, the fuel supply unit 31 includes a fuel injection port 32, which communicates with the fuel introducing port 30A, and a plurality of fuel discharge ports 33, and is configured such that the fuel injection port 32 and the fuel discharge ports 33 are connected via a fuel passage such as a fine tube 34. The membrane electrode assembly 2 is disposed such that the anode 13 is opposed to the above-described fuel discharge ports 33 of the fuel supply unit 31.

The cover plate 21 has a substantially rectangular outer shape, and is formed of, e.g. stainless steel (SUS). In addition, the cover plate 21 has a plurality of opening portions (also referred to as “oxygen introducing ports”) 21A for mainly taking in air (especially, oxygen) that is an oxidant. Specifically, the opening portions 21A are through-holes penetrating from the outer surface of the cover plate 21 to the surface opposed to the cathode 16.

The cover plate 21 is fixed to the container 30 by a method of caulking, screwing or rivet coupling in the state in which the membrane electrode assembly 2 is held between the cover plate 21 and the fuel supply mechanism 3. Thereby, a power generation unit of the fuel cell (DMFC) 1 is constructed.

A liquid fuel corresponding to the membrane electrode assembly 2 is contained in the fuel container 4. Examples of the liquid fuel include methanol fuels such as methanol aqueous solutions of various concentrations, or pure methanol. The liquid fuel is not necessarily limited to the methanol fuels. The liquid fuel may be, for instance, an ethanol fuel such as an ethanol aqueous solution or pure ethanol, a propanol fuel such as a propanol aqueous solution or pure propanol, a glycol fuel such as a glycol aqueous solution or pure glycol, dimethyl ether, formic acid, or other liquid fuel. In any case, the liquid fuel corresponding to the membrane electrode assembly 2 is contained in the fuel container 4.

Further, a pump 6 may be provided on the conduit 5. The pump 6 is not a circulating pump for circulating fuel, but a fuel supply pump for feeding liquid fuel from the fuel container 4 to the fuel supply unit 31. The fuel, which is supplied from the fuel supply unit 31 to the membrane electrode assembly 2, is used in a power generation reaction, and then the fuel is not circulated or returned to the fuel container 4.

In the fuel cell 1 of this embodiment, the fuel is not circulated. Thus, this fuel cell 1 differs from the conventional active-type fuel cell, and the reduction in size of the apparatus is not hindered. Moreover, the pump 6 is used for supplying liquid fuel. Thus, this fuel cell 1 differs from the conventional pure passive type, such as an internal evaporation type. In the fuel cell 1 shown in FIG. 1, a method called “semi-passive type”, for example, is applied.

As has been described above, the fuel, which is discharged from the fuel supply unit 31, is supplied to the anode 13 of the membrane electrode assembly 2. In the membrane electrode assembly 2, the fuel diffuses in the anode gas diffusion layer 12, and is supplied to the anode catalyst layer 11. When methanol fuel is used as the liquid fuel, an internal reforming reaction of methanol, which is shown in formula (1) below, occurs in the anode catalyst layer 11. In the meantime, when pure methanol is used as the methanol fuel, water, which is generated in the cathode catalyst layer 14, or water in the electrolyte membrane 17 is caused to react with the methanol, and the internal reforming reaction shown in formula (1) is caused to occur. Alternatively, an internal reforming reaction is caused to occur by another reaction mechanism which requires no water.

CH₃OH+H₂O→CO₂+6H⁺+6e⁻ (1)

The electrons (e⁻) generated in this reaction are led to the outside via an electricity-collecting member 18, and drive, as so-called electricity, a mobile electronic apparatus or the like. Then, the electrons (e⁻) are led to the cathode 16 via the electricity-collecting member 18. The protons (H⁺) generated in the internal reforming reaction of formula (1) are led to the cathode 16 via the electrolyte membrane 17. Air is supplied, as an oxidant, to the cathode 16. The electrons (e⁻) and the protons (H⁺), which have reached the cathode 16, react with oxygen in the air in the cathode catalyst layer 14 according to a formula (2) below, and water is generated by this reaction.

6e⁻+6H⁺+(3/2)O₂→3H₂O (2)

In the above-described power generation reaction of the fuel cell 1, in order to increase electric power which is generated, it is important to smoothly cause the catalyst reaction to occur, to uniformly supply fuel to the entire electrode of the membrane electrode assembly 2, and to cause the entire electrode to efficiently contribute to power generation.

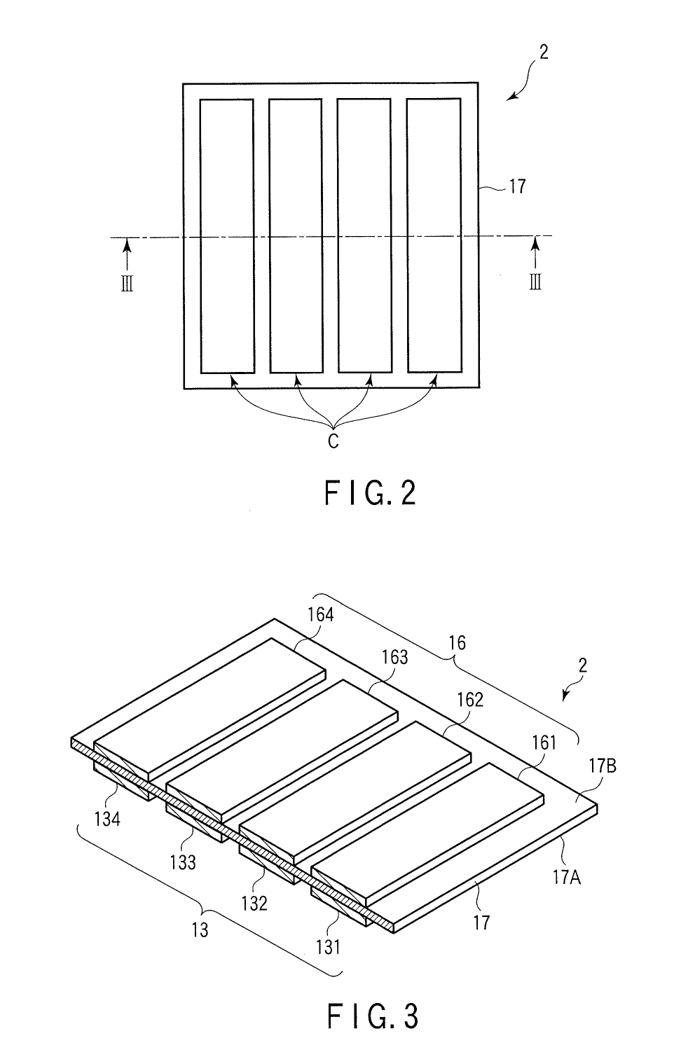

In the present embodiment, as shown in FIG. 2 and FIG. 3, the membrane electrode assembly 2 comprises a plurality of anodes 13 which are disposed at intervals on one surface 17A of a single electrolyte membrane 17, and a plurality of cathodes 16 which are disposed at intervals on the other surface 17B of the electrolyte membrane 17 with a distance from the anodes 13.

The respective combinations of the anodes 13 and cathodes 16 clamp the electrolyte membrane 17 and constitute unit cells C. The respective unit cells C are arranged on the same plane at intervals in a direction perpendicular to the longitudinal direction thereof. The structure of the membrane electrode assembly 2 is not limited to this example, and may have other structures.

In the example illustrated, the membrane electrode assembly 2 includes four anodes 131 to 134 which are disposed on one surface 17A of the single electrolyte membrane 17, and four cathodes 161 to 164 which are disposed on the other surface 17B of the electrolyte membrane 17. The anode 131 and cathode 161 are disposed to be opposed to each other, thereby constituting one unit cell C. Similarly, the anode 132 and cathode 162 are disposed to be opposed to each other, the anode 133 and cathode 163 are disposed to be opposed to each other, and the anode 134 and cathode 164 are disposed to be opposed to each other. Thus, four unit cells C are arranged on the same plane.

In the membrane electrode assembly 2 including a plurality of unit cells C, as shown in FIG. 2 and FIG. 3, the unit cells are electrically connected in series by the electricity-collecting member 18.

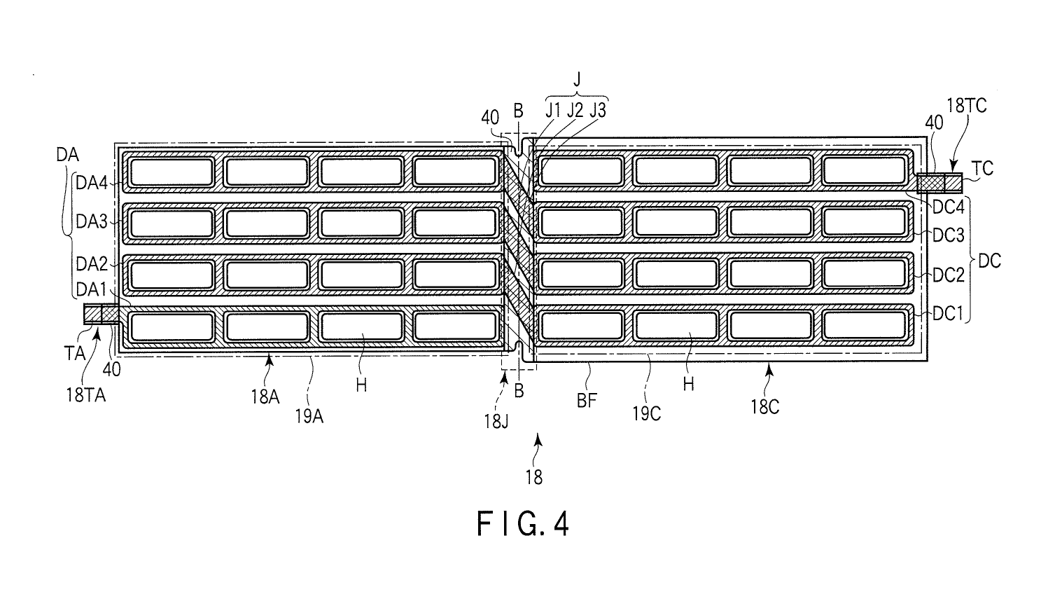

As shown in FIG. 4, the electricity-collecting member 18 includes the anode electricity collector 18A, the cathode electricity collector 18C, and a connection portion 18J which connects the anode electricity collector 18A and the cathode electricity collector 18C. The area of the anode electricity collector 18A is substantially equal to that of the cathode electricity collector 18C. The connection portion 18J is located between the anode electricity collector 18A and the cathode electricity collector 18C. The electricity-collecting member 18 is folded double along a folding line at a position B in the connection portion 18J in the Figure, thereby clamping the membrane electrode assembly 2.

An insulative base film BF, which constitutes the electricity-collecting member 18, has an area that is about double the outside size of the membrane electrode assembly 2, and the base film BF extends in a direction perpendicular to the direction of arrangement of the unit cells C in the membrane electrode assembly 2. The base film BF should desirably be formed of a material which has, needless to say, electrical insulation properties, and also has corrosion resistance to a fuel (e.g. methanol) that is used or a by-product (e.g. formic acid) which is produced by an electricity generating reaction. For example, the base film BF is formed of a resin film of polyimide (PI), polyethylene terephthalate (PET), polyethylene naphthalate (PEN) or polyamide-imide (PAI).

The electrode member DA of the anode electricity collector 18A is provided on the base film BF in association with each of the anodes 13. The number of electrode members DA is equal to the number of anodes 13 included in the membrane electrode assembly 2. In addition, the electrode member DC of the cathode electricity collector 18C is provided on the base film BF in association with each of the cathodes 16. The number of electrode members DC is equal to the number of cathodes 16 included in the membrane electrode assembly 2. The electrode members DA and DC are formed on the same surface of the base film BF.

In the example shown in FIG. 4, the anode electricity collector 18A includes four electrode members DA1 to DA4. In addition, the cathode electricity collector 18C includes four electrode members DC1 to DC4.

In the anode electricity collector 18A, the electrode member DA1 is disposed to correspond to the anode 131. Similarly, the electrode member DA2 is disposed to correspond to the anode 132, the electrode member DA3 is disposed to correspond to the anode 133, and the electrode member DA4 is disposed to correspond to the anode 134. In the cathode electricity collector 18C, the electrode member DC1 is disposed to correspond to the cathode 161. Similarly, the electrode member DC2 is disposed to correspond to the cathode 162, the electrode member DC3 is disposed to correspond to the cathode 163, and the electrode member DC4 is disposed to correspond to the cathode 164.

The anode electricity collector 18A and the cathode electricity collector 18C have a plurality of through-holes H which penetrate the base film BF. In the anode electricity collector 18A, the fuel, which is supplied from the fuel supply mechanism 3 via the through-holes H, can be supplied to the anode catalyst layer 11. In addition, in the cathode electricity collector 18C, oxygen and water vapor can be supplied to the cathode catalyst layer 14 via the through-holes H, and a gas, such as carbon dioxide or excess water vapor, can be exhausted to the outside.

The electricity-collecting member 18 includes an anode terminal 18TA which is connected to the anode electricity collector 18A, and a cathode terminal 18TC which is connected to the cathode electricity collector 18C. The anode terminal 18TA and cathode terminal 18TC function as output terminals which take out collected electrons to the outside.

The anode terminal 18TA includes a conductor TA which is connected to the electrode member DA1. The conductor TA is formed of the same material as the electrode member DA1 and is formed integral with the electrode member DA1. The cathode terminal 18TC includes a conductor TC which is connected to the electrode member DC4. The electrode member DC4 is disposed at a remotest position from the electrode member DA1. The conductor TC is formed of the same material as the electrode member DC4 and is formed integral with the electrode member DC4.

Those electrode members of the anode electricity collector 18A and cathode electricity collector 18C, which are not connected to the anode terminal 18TA and cathode terminal 18TC, are electrically connected by conductors J of the connection portion 18J. In the example shown in FIG. 4, the electrode member DA2 and electrode member DC1 are connected by a conductor J1. Similarly, the electrode member DA3 and electrode member DC2 are connected by a conductor J2, and the electrode member DA4 and electrode member DC3 are connected by a conductor J3. Needless to say, the conductors J, together with the electrode members DA and DC, are formed on the same surface of the base film BF. In short, the respective conductors J are formed of the same material as the electrode members DA and electrode members DC which are connected thereto, and are formed integral with these electrode members DA and electrode members DC.

The electrode members DA, electrode members DC, conductors J, conductor TA and conductor TC are formed of, for example, a porous layer (e.g. mesh) of a metallic material such as copper, gold or nickel, or an electrically conductive metallic material such as a foil or a thin film.

The electricity-collecting member 18 includes an insulative protection film 40 which covers at least the conductors J of the connection portion 18J. In the example shown in FIG. 4, in the connection portion 18J, the protection film 40, together with the conductors J1 to J3, is disposed so as to cover the base film BF. The connection portion 18J, as described above, is folded double when the membrane electrode assembly 2 is clamped by the electricity-collecting member 18.

At this time, a great load acts on the conductors J which cross the folding line indicated by B in FIG. 4. However, since the conductors J are covered with the protection film 40, breaking of each conductor J can be prevented. In addition, since the protection film 40 prevents exposure of each conductor J, it is possible to secure corrosion resistance to a fuel (e.g. methanol) that is used or a by-product (e.g. formic acid) which is produced by an electricity generating reaction.

In addition, the electricity-collecting member 18 includes an insulative protection film 40 which covers at least one of the conductors TA and TC of the anode terminal 18TA and cathode terminal 18TC.

In the example shown in FIG. 4, at the anode terminal 18TA, the protection film 40 is disposed so as to cover the base film BF as well as the conductor TA crossing the anode seal member 19A. The anode terminal 18TA is locally pressurized by the anode seal member 19A when the membrane electrode assembly 2 is held between the fuel supply mechanism 3 and cover plate 21 in the state in which the membrane electrode assembly 2 is clamped by the electricity-collecting member 18.

In addition, at the cathode terminal 18TC, the protection film 40 is disposed so as to cover the base film BF as well as the conductor TC crossing the cathode seal member 19C. The cathode terminal 18TC is locally pressurized by the cathode seal member 19C when the membrane electrode assembly 2 is held between the fuel supply mechanism 3 and cover plate 21 in the state in which the membrane electrode assembly 2 is clamped by the electricity-collecting member 18.

At this time, a great load acts on the conductors TA and TC. However, since the conductors TA and TC are covered with the protection film 40, breaking of the conductors TA and TC can be prevented. In addition, since the protection film 40 prevents exposure of the conductors TA and TC, it is possible to secure corrosion resistance to a fuel (e.g. methanol) that is used or a by-product (e.g. formic acid) which is produced by an electricity generating reaction.

In the meantime, as regards the conductors J in the connection portion 18J, the conductors J between the respective electrode members DA and the folding line B cross the anode seal member 19A and are locally pressurized. However, since these conductors J are covered with the protection film 40, the conductors J are protected. Similarly, the conductors J between the respective electrode members DC and the folding line B cross the cathode seal member 19C and are locally pressurized. However, since these conductors J are covered with the protection film 40, the conductors J are protected.

At that distal end portion of the anode terminal 18TA, which extends outward from the position of crossing with the anode seal member 19A, the conductor TA is exposed from the protection film 40. Similarly, at that distal end portion of the cathode terminal 18TC, which extends outward from the position of crossing with the cathode seal member 19C, the conductor TC is exposed from the protection film 40. Thereby, electrical connection can be established between the anode terminal 18TA and cathode terminal 18TC and the outside.

The above-described protection film 40 should desirably be formed of a material which has, needless to say, electrical insulation properties, and also has corrosion resistance to a fuel (e.g. methanol) that is used or a by-product (e.g. formic acid) which is produced by an electricity generating reaction. For example, the protection film 40 is formed of a resin film of polyimide (PI), polyethylene terephthalate (PET), polyethylene naphthalate (PEN) or polyamide-imide (PAI).

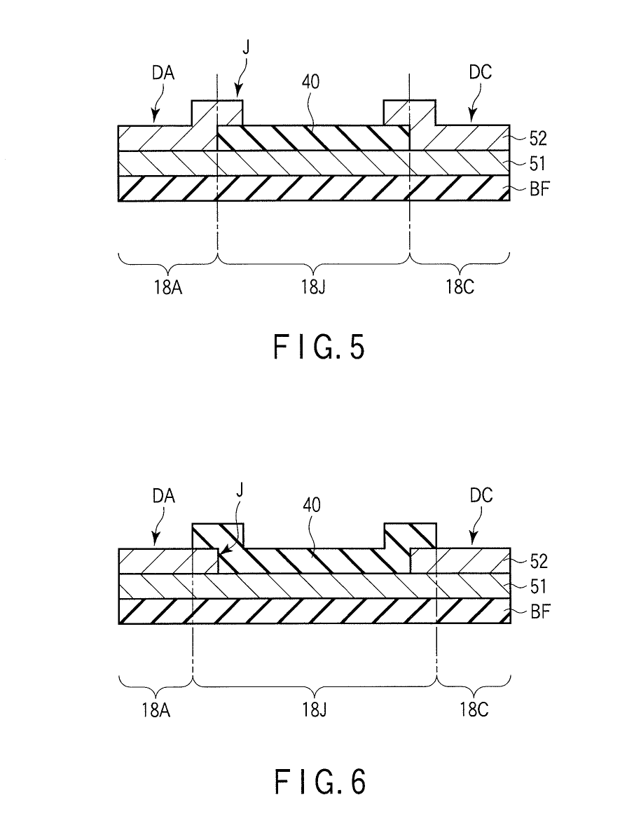

FIG. 5 shows a structure example of the connection portion 18J.

Specifically, the conductor J includes a first conductor layer 51 which is disposed on the base film BF, and a second conductor layer 52 which overlaps end portions of the protection film 40 covering the first conductor film 51. In this example, the second conductor layer 52 is stacked on a periphery of the protection film 40. The electrode member DA of anode electricity collector 18A and the electrode member DC of cathode electricity collector 18C include, respectively, a first conductor layer 51 extending from the conductor J, and a second conductor layer 52 covering the first conductor layer 51 and extending from the conductor J.

The first conductor layer 51 is formed of, e.g. a copper foil. The second conductor layer 52 is formed of an electrically conductive resin with corrosion resistance to fuel, such as carbon resin. In addition, the second conductor layer 52 should desirably have corrosion resistance to a by-product (e.g. formic acid) which is produced by an electricity generating reaction. Thus, the exposure of the first conductor layer 51 from the end portion of the protection film 40 can be prevented, and the corrosion resistance of the first conductor layer 51 can further be improved.

FIG. 6 shows another structure example of the connection portion 18J. The same structural parts as in the example shown in FIG. 5 are denoted by like reference numerals, and a description thereof is omitted.

The example shown in FIG. 6 includes a second conductor layer 52 which overlaps end portions of the protection film 40 covering the first conductor layer 51. The difference is that the protection film 40 is stacked on the end portions of the second conductor layer 52. In this example, too, the exposure of the first conductor layer 51 from the end portion of the protection film 40 can be prevented, and the corrosion resistance of the first conductor layer 51 can further be improved.

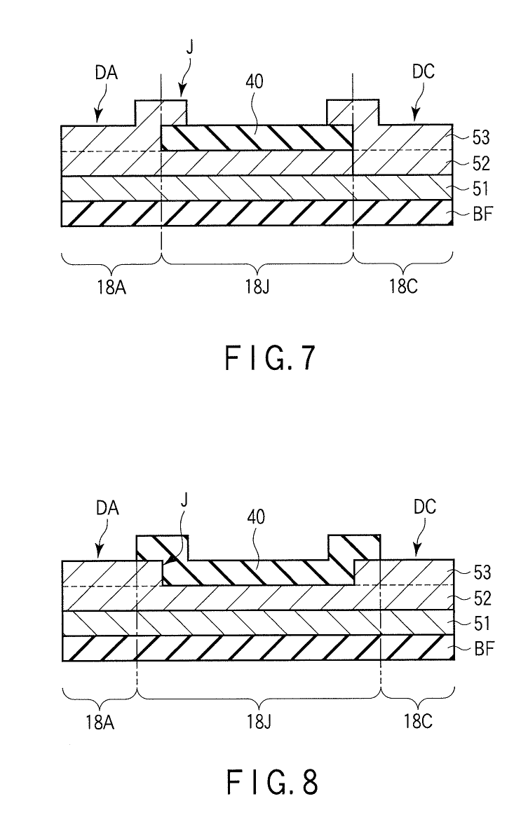

FIG. 7 shows still another structure example of the connection portion 18J.

Specifically, the conductor J includes a first conductor layer 51 which is disposed on the base film BF, a second conductor layer 52 which covers the first conductor layer 51, and a third conductor layer 53 which overlaps end portions of the protection film 40 covering the second conductor film 52. In this example, the third conductor layer 53 is stacked on a periphery of the protection film 40. The electrode member DA of anode electricity collector 18A and the electrode member DC of cathode electricity collector 18C include, respectively, a first conductor layer 51 extending from the conductor J, a second conductor layer 52 covering the first conductor layer 51 and extending from the conductor J, and a third conductor layer 53 which is stacked on the second conductor layer 52 and extends from the conductor J.

The second conductor layer 52 and third conductor layer 53 are formed of an electrically conductive resin with corrosion resistance to fuel, such as carbon resin. The second conductor layer 52 and third conductor layer 53 may be formed of different materials. In addition, the second conductor layer 52 and third conductor layer 53 should desirably have corrosion resistance to a by-product (e.g. formic acid) which is produced by an electricity generating reaction. In this example, too, the exposure of the first conductor layer 51 from the end portion of the protection film 40 can be prevented, and the corrosion resistance of the first conductor layer 51 can further be improved.

FIG. 8 shows still another structure example of the connection portion 18J. The same structural parts as in the example shown in FIG. 7 are denoted by like reference numerals, and a description thereof is omitted.

The example shown in FIG. 8 includes a third conductor layer 53 which overlaps end portions of the protection film 40 covering the second conductor layer 52. Also in this example which is different in that the protection film 40 is stacked on the end portions of the third conductor layer 53, the exposure of the first conductor layer 51 from the end portion of the protection film 40 can be prevented, and the corrosion resistance of the first, conductor layer 51 can further be improved.

The examples shown in FIG. 5 to FIG. 8 have been described as structure examples of the connection portion 18J. However, these examples are applicable as structure examples of the anode terminal 18TA or cathode terminal 18TC.

### Examples

As Example 1, an electricity-collecting member 18, in which a connection portion 18J having a structure as shown in FIG. 5 is formed on the base film BF, was prepared. The conductor J of the connection portion 18J was substantially the first conductor layer 51 alone. The protection film 40 was disposed on the first conductor layer 51, and the second conductor layer 52 was disposed on the periphery of the protection film 40.

As Example 2, an electricity-collecting member 18, in which a connection portion 18J having a structure as shown in FIG. 7 is formed on the base film BF, was prepared. The conductor J of the connection portion 18J was substantially a two-layer structure in which the first conductor layer 51 and second conductor layer 52 were stacked. The protection film 40 was disposed on the second conductor layer 52, and the third conductor layer 53 was disposed on the periphery of the protection film 40.

In a comparative example, the conductor J of the connection portion 18J on the base film BF was substantially a two-layer structure in which the first conductor layer 51 and second conductor layer 52 were stacked, and the protection film was not disposed.

In Example 1, Example 2 and the comparative example, the first conductor layer 51 was formed of a copper foil, and the second conductor layer 52 was formed of a carbon resin. In Example 1 and Example 2, the protection film 40 was formed of polyimide (PI). In Example 2, the third conductive layer 53 was formed of a carbon resin.

As regards these three kinds of electricity-collecting members 18, a folding test was first conducted.

In the folding test, a glass epoxy substrate in which a slit is formed is prepared as a jig. As shown in FIG. 9, the electricity-collecting member 18 was passed through the slit SL, and was folded double at the connection portion 18J so as to sandwich the glass epoxy substrate SUB. These were clamped between a pair of glass substrates SUB1 and SUB2. A weight of 1 kg was rolled over one glass substrate SUB2 in a direction of an arrow in the Figure.

This test was conducted by varying the thickness of the glass epoxy substrate SUB. Glass epoxy substrates SUB having the following thicknesses were prepared: 2.0 mm (the radius of curvature, R, of the folded connection portion 18J corresponds to 1.0 mm); 1.2 mm (the radius of curvature, R, of the folded connection portion 18J corresponds to 0.6 mm); and 0.4 mm (the radius of curvature, R, of the folded connection portion 18J corresponds to 0.2 mm). The test was also conducted in the case where the glass epoxy substrate was absent (the radius of curvature, R, of the folded connection portion 18J corresponds to 0 mm).

The test was conducted under two conditions for folding the electricity-collecting member 18: A) the electricity-collecting member 18 is folded, with the base film BF being directed to the inside, and the conductor J being directed to the outside, and B) the electricity-collecting member 18 is folded, with the base film BF being directed to the outside, and the conductor J being directed to the inside.

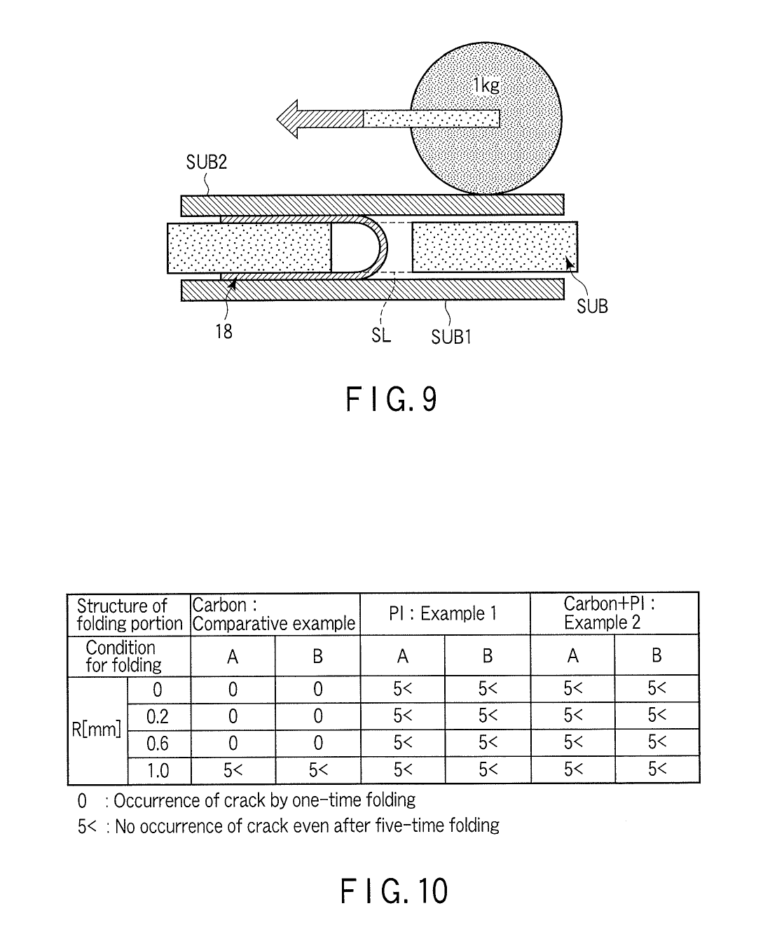

The result of the test is as shown in FIG. 10. In Example 1 and Example 2, no crack occurred at any of the radii of curvature, R, regardless of the condition for folding. By contrast, in the comparative example, a crack occurred in the conductor J by one test, when the radius of curvature, R, of the connection portion 18J was less than 1 mm. Thereby, it was confirmed that the occurrence of breaking along the folding line was successfully prevented in Example 1 and Example 2.

Next, an acid resistance test was conducted on the three kinds of electricity-collecting members 18 (Example 1, Example 2, comparative example).

In this acid resistance test, a mixture solution of formic acid of 2000 ppm and methanol of 1.5 mol/l was prepared. The entirety of each of the three kinds of electricity-collecting members 18 was immersed in the mixture solution, and was left to stand still in a constant-temperature bath at 60° C. After the immersion for two weeks (336 hours), the three kinds of electricity-collecting members 18 were taken out, and the elution amount of copper was analyzed by an inductively coupled plasma mass spectrometer (ICP-MS).

In the comparative example and Example 1, the elution amount of copper was 5 ppm or less. In Example 2, the elution amount of copper was 0.1 ppm or less. Thereby, it was confirmed that the elution amount of copper was very small in any of the examples. In particular, it was confirmed that according to Example 2, the elution amount of copper can be more reduced than in Example 1, and a higher corrosion resistance can be obtained.

As has been described above, according to the present embodiment, a fuel cell, which can prevent breaking in an electricity-collecting member and can secure corrosion resistance, can be provided.

The fuel cell 1 of the above-described embodiment exhibits effects when various kinds of liquid fuels are used, and the kind and concentration of liquid fuel are not restricted. However, the fuel supply unit 31, which supplies fuel while dispersing it in a plane direction is particularly effective when the fuel concentration is high. Thus, the fuel cell 1 of the embodiment can particularly exhibit its capability and effect when methanol with a concentration of 80 wt % or more is used as liquid fuel. Accordingly, the embodiment is suited to the fuel cell 1 which uses, as liquid fuel, a methanol aqueous solution with a methanol concentration of 80 wt % or more, or pure methanol.

The above-described embodiment has been directed to the case applied to the semi-passive type fuel cell 1. However, this embodiment is not limited to this case, and may be applied to pure-passive type fuel cells of an internal evaporation type.

The present embodiment is applicable to various kinds of fuel cells using liquid fuel. The concrete structures of the fuel cell and the supply condition of fuel are not particularly limited. The embodiment is applicable to various modes in which all of fuel supplied to the MEA is vapor of liquid fuel, all of fuel is liquid fuel, or part of fuel is vapor of liquid fuel which is supplied in a liquid state.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A fuel cell comprising:
a membrane electrode assembly comprising an anode, a cathode, and an electrolyte membrane interposed between the anode and the cathode; and
an electricity-collecting member comprising an anode electricity collector having a first electrode member which is in contact with the anode, a cathode electricity collector having a second electrode member which is in contact with the cathode, a connection portion having a conductor which connects the anode electricity collector and the cathode electricity collector, and an insulative protection film covering at least the conductor of the connection portion.

2. A fuel cell comprising:
a membrane electrode assembly comprising an anode, a cathode, and an electrolyte membrane interposed between the anode and the cathode; and
an electricity-collecting member comprising an anode electricity collector having a first electrode member which is in contact with the anode, a cathode electricity collector having a second electrode member which is in contact with the cathode, an anode terminal including a first conductor connected to the anode electricity collector, a cathode terminal including a second conductor connected to the cathode electricity collector, and an insulative protection film covering at least one of the first conductor of the anode terminal and the second conductor of the cathode terminal.

3. The fuel cell of claim 2, further comprising a frame-shaped anode seal member which surrounds the anode and the anode electricity collector and crosses the anode terminal,
wherein the anode terminal comprises a distal end portion which extends outward from a position of crossing with the anode seal member, and the first conductor of the distal end portion is exposed from the protection film.

4. The fuel cell of claim 2, further comprising a frame-shaped cathode seal member which surrounds the cathode and the cathode electricity collector and crosses the cathode terminal,
wherein the cathode terminal comprises a distal end portion which extends outward from a position of crossing with the cathode seal member, and the second conductor of the distal end portion is exposed from the protection film.

5. The fuel cell of claim 1, wherein the conductor comprises a first conductor layer and a second conductor layer which overlaps an end portion of the protection film covering the first conductor layer.

6. The fuel cell of claim 5, wherein the second conductor layer is formed of an electrically conductive resin.

7. The fuel cell of claim 2, wherein each of the first conductor and the second conductor comprises a first conductor layer and a second conductor layer which overlaps an end portion of the protection film covering the first conductor layer.

8. The fuel cell of claim 7, wherein the second conductor layer is formed of an electrically conductive resin.

9. The fuel cell of claim 1, wherein the conductor comprises a first conductor layer, a second conductor layer covering the first conductor layer, and a third conductor layer which overlaps an end portion of the protection film covering the second conductor layer.

10. The fuel cell of claim 9, wherein the second conductor layer and the third conductor are formed of an electrically conductive resin with corrosion resistance to fuel.

11. The fuel cell of claim 2, wherein each of the first conductor and the second conductor comprises a first conductor layer, a second conductor layer covering the first conductor layer, and a third conductor layer which overlaps an end portion of the protection film covering the second conductor layer.

12. The fuel cell of claim 11, wherein the second conductor layer and the third conductor are formed of an electrically conductive resin with corrosion resistance to fuel.

13. The fuel cell of claim 1, wherein each of the first electrode member of the anode electricity collector and the second electrode member of the cathode electricity collector comprises a first conductor layer and a second conductor layer covering the first conductor layer.

14. The fuel cell of claim 13, wherein each of the first electrode member of the anode electricity collector and the second electrode member of the cathode electricity collector further comprises a third conductor layer which is stacked on the second conductor layer.

15. The fuel cell of claim 2, wherein each of the first electrode member of the anode electricity collector and the second electrode member of the cathode electricity collector comprises a first conductor layer and a second conductor layer covering the first conductor layer.

16. The fuel cell of claim 15, wherein each of the first electrode member of the anode electricity collector and the second electrode member of the cathode electricity collector further comprises a third conductor layer which is stacked on the second conductor layer.
